(19) United States
(12) Patent Application Publication
(10) Pub. No.: US 2025/0001227 A1
(43) Pub. Date: Jan. 2, 2025

(54) SYSTEMS AND METHODS FOR INDICATING DEVICE STATE

(71) Applicant: Tyco Fire Products LP, Cranston, RI (US)

(72) Inventors: Jackson Leclerc, Cranston, RI (US); Joshua Motha, Tiverton, RI (US)

(73) Assignee: Tyco Fire Products LP, Cranston, RI (US)

(21) Appl. No.: 18/705,235

(22) PCT Filed: Jan. 4, 2023
(86) PCT No.: PCT/IB2023/050069

§ 371 Date: Apr. 26, 2024

Related U.S. Application Data
(60) Provisional application No. 63/296,618, filed on Jan. 5, 2022.
(60) Provisional application No. 63/356,174, filed on Jun. 28, 2022.

(51) Int. Cl. A62C 37/50; A62C 35/62

(52) U.S. Cl. CPC A62C 37/50; A62C 35/62

(57) ABSTRACT

Fire suppression systems and methods are provided. The fire suppression system can include a data processing system. The data processing system can be communicably coupled with a sensor. The sensor can sense system information indicative of a state of the fire suppression system. The data processing system can receive a signal from the sensor indicating the system information. The data processing system can determine the state of the fire suppression system based on the system information. The data processing system can identify a location to apply a voltage in order to indicate the state of the fire suppression system. The data processing system can apply the voltage to the location. The data processing system can transmit, responsive to application of the voltage to the location, an indication of the state of the fire suppression system to an external computing device, and present a visual representation of the indication.

### CROSS-REFERENCE TO RELATED APPLICATIONS

The present application claims the benefit of and priority to U.S. Provisional Application No. 63/356,174, filed Jun. 28, 2022, and U.S. Provisional Application No. 63/296,618, filed Jan. 5, 2022, the contents of which are incorporated herein by reference in their entireties.

### BACKGROUND

Fire protection systems can use sprinklers to output fire suppression fluids to address a fire condition. For example, sprinklers can be triggered to output fluids responsive to sensing the fire condition.

### SUMMARY

At least one aspect is directed to a data processing system. The data processing system can be communicably coupled with a sensor. The sensor can sense system information indicative of a state of the fire suppression system. The data processing system can receive a signal from the sensor indicating the system information. The data processing system can determine the state of the fire suppression system based on the system information. The data processing system can identify a location to apply a voltage in order to indicate the state of the fire suppression system. The data processing system can apply the voltage to the location. The data processing system can transmit, responsive to application of the voltage to the location, an indication of the state of the fire suppression system to an end user computing device.

At least one aspect is directed to a method. The method can include receiving, by a data processing system, a signal from a sensor. The signal can indicate system information. The method can include determining, by the data processing system, a state of the fire suppression system based on the system information. The method can include identifying, by the data processing system, a location to apply a voltage. The location can be indicative of the state of the fire suppression system. The method can include applying, by the data processing system, the voltage to the identified location. The method can include transmitting, by the data processing system, a signal to an external computing device. The transmitted signal can indicate the state of the fire suppression system.

At least one aspect is directed to a system. The system can include a sensor to detect sensor data of one or more components of a fire suppression system. The system can include one or more processors to determine a state of the one or more components based on the sensor data, identify a particular location of a plurality of locations of an output component associated with the state responsive to determining the state, apply a voltage to the particular location, and cause an indicator to present an indication of the state.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 depicts an example fire suppression system.

FIG. 2 depicts a schematic diagram of an example fire suppression system.

FIG. 3 depicts a perspective view of an example system connector.

FIG. 4 depicts a schematic illustration of an example data processing system.

FIG. 5 is a flow diagram depicting an example method.

### DETAILED DESCRIPTION

Following below are more detailed descriptions of various concepts related to, and implementations of, systems, methods, and apparatuses of sprinklers (e.g., concealed water mist sprinklers). The various concepts introduced above and discussed in greater detail below may be implemented in any of numerous ways, including but not limited to in residential applications or other applications that use relatively low flow rates.

The present disclosure generally relates to a fire suppression system. More specifically, the present disclosure relates to a data processing system that can monitor and control the fire suppression system. The data processing system can receive information from sensors in real time so that the data processing system can determine a state of the fire suppression system. Sensing normal numbers and information (e.g., parameters associated with the state that meet target conditions, such as minimum and/or maximum thresholds) can indicate that the fire suppression system is operating properly. Sensing abnormal numbers and information (e.g., parameters associated with the state that do not meet the target conditions) can indicate that the fire suppression system has entered a non-normal state. The non-normal state can include a high/low state (e.g., supervisory state), an alarm state, and a tampered state, among others. The states can correspond to any part or component of the fire suppression system including the piping, a valve, a sprinkler, the data processing system, an access barrier to the data processing system, among others. Having the data processing system monitor the fire suppression system and determine the state of the fire suppression system can allow for the status of the fire suppression system to be observed at remote locations, without requiring (or requiring less) physical inspection and testing of the fire suppression system. For example, a device of the data processing system can include a display device, such as an LED light, to indicate the state of the fire suppression system, and the device can be located in a location remote from the sensors (and thus remote from the components of the fire suppression system being monitored), allowing the state of the fire suppression system to be identified by a user without needing to access particular locations of the components.

The system described herein can include various configurations. The system can determine the state of the fire suppression system based on various information received from sensors. A normal state can be determined when the information a sensor senses corresponds to predetermined set points or thresholds. The non-normal states can be determined when the information indicates a deviation from the predetermined set points and thresholds. For example, a high/low state can be determined based on a sensor sensing a pressure within a pipe of the fire suppression system that is different than a predetermined pressure set point. An alarm state can be determined based on a sensor sensing a rate of decrease in pressure of a pipe of the fire suppression system that exceeds a predetermined threshold. A tampered state can be determined based on a sensor sensing an access barrier of the data processing system was moved to an open position. Based on the determined state of the fire suppression system, the system can relay information to an external computing device, can receive commands from another system, and can respond to the determination of the state based on previously provided instructions; the system can use a display device to communicate the state in real time.

For example, a sensor can sense a rate of decrease in pressure within a pipe of the fire suppression system that is greater than a predetermined rate of decrease threshold. The sensor can send information regarding the rate of decrease in pressure within the pipe to the data processing system. The data processing system can determine that the fire suppression system is in an alarm state based on the information received from the sensor. The data processing system can apply a voltage to a specific location within the data processing system indicating the fire suppression system is in the alarm state. The data processing system can at least one of transmit a signal to an external computing device indicating the state of the system based on the location that receives the voltage and cause a display device to output an indication of the state. The data processing system can transmit a signal to a valve coupled with a pipe of the fire suppression system responsive to detecting the fire suppression system is in the alarm state. The signal can cause the valve to open to allow fire suppression fluid to flow through the pipe to an outlet. In a dry pipe system, transmitting a signal to the valve can cause the valve to open quicker than having to wait until a sensor at the valve detects a threshold air pressure. As such, transmitting the signal can cause fire suppression agent (e.g., water) to reach an outlet (e.g., a sprinkler) and provide fire protection quicker than systems that wait to detect a threshold air pressure.

The sprinkler and various other components of the system can be used for storage applications, including but not limited to use for ceiling-only systems, and for ceiling heights up to and over fifty five feet. For example, the system can be used for storage commodities such as Class I, II, III or IV, Group A, Group B, or Group C plastics, elastomers, or rubber commodities, or any combination thereof. The storage commodity can be in an arrangement such as a single-row rack arrangement, a double-row rack arrangement, a multi-row rack arrangement, a palletized arrangement, a solid-piled arrangement, a bin box arrangement, a shelf arrangement, a back-to-back shelf arrangement, an on floor arrangement, and a rack without solid shelves arrangement, or any combination thereof. The system can be used in accordance with various standards, such as standards set forth by the National Fire Protection Association (NFPA) or FM Global.

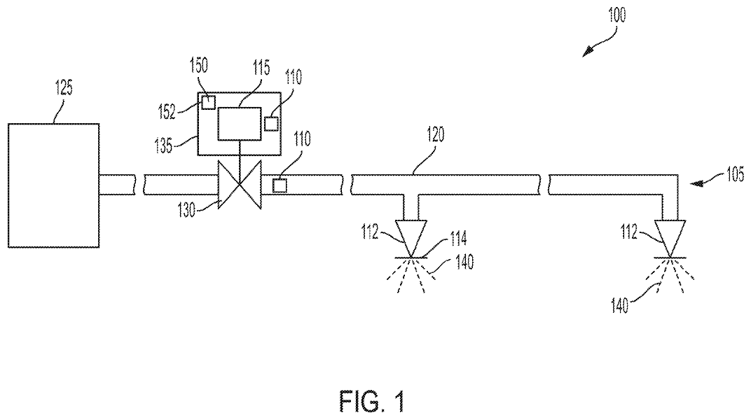

FIG. 1 depicts an example of a fire suppression system 100. The fire suppression system 100 can be a chemical fire suppression system. The fire suppression system 100 can distribute a fire suppression agent onto or nearby a fire, extinguishing the fire and preventing the fire from spreading. The fire suppression system 100 can be used alone or in combination with other types of fire suppression systems (e.g., a building sprinkler system, a handheld fire extinguisher). Multiple fire suppression systems 100 can be used in combination with one another to cover a larger area (e.g., each in different rooms of a building).

The fire suppression system 100 can be used in a variety of applications. The fire suppression system 100 can be used with a variety of fire suppression agents, including but not limited to water (e.g., may use powders, liquids, foams, or other fluid or flowable materials). The fire suppression system 100 can be used for storage applications, including ceiling-only, in-rack, or a combination of ceiling and rack sprinklers, such as to be installed for storage commodities such as Class I, II, III or IV, Group A, Group B, or Group C plastics, elastomers, or rubber commodities, or any combination thereof. The storage commodity can be in an arrangement such as a single-row rack arrangement, a double-row rack arrangement, a multi-row rack arrangement, a palletized arrangement, a solid-piled arrangement, a bin box arrangement, a shelf arrangement, a back-to-back shelf arrangement, an on floor arrangement, and a rack without solid shelves arrangement, or any combination thereof.

The fire suppression system 100 can include at least one sprinkler system 105, at least one sensor 110, and at least one data processing system 115. The sprinkler system 105 can include at least one sprinkler 112, piping 120, at least one fluid supply 125, and at least one valve 130. The fluid supply 125 can define an internal volume filled (e.g., partially filled, completely filled) with fire suppression agent. The fluid supply 125 can provide fluid from a remote or local location to a building in which the fire suppression system 100 is located. The fluid supply 125 can include, for example, a municipal water supply, pump, piping system, tank, cylinder, or any other source of water or fire suppression agent.

The piping 108 (e.g., one or more pipes, tubes, conduits) can be fluidly coupled with the at least one sprinkler 112. The sprinklers 112 can receive water or other fire suppression agent from the fluid supply 125 via the piping 120. The sprinklers 112 can each define one or more outlets, through which the fire suppression agent exits and contacts a deflector 114, such as to form a spray of water or other fire suppression agent that covers a desired area. The sprays from the sprinklers 112 then suppress or extinguish fire within that area. The deflectors 114 of the sprinklers 112 can be shaped to control the spray pattern of the fire suppression agent leaving the sprinklers 112. The sprinklers 112 can be used as concealed sprinklers, pendent sprinklers, upright sprinklers, water mist nozzles, or any other device for spraying fire suppression agent.

The fire suppression system 100 can monitor and control components associated with the sprinkler system 105 and the data processing system 115. For example, the fire suppression system 100 can control the valve 130 of the sprinkler system 105 (e.g., send a signal to open the valve 130). For example, the fire suppression system 100 can implement the data processing system 115 or components thereof as at least one of a quick release switch and an electronic accelerator, such as to open the valve 130 responsive to detecting a fire condition based on pressure data from sensors 110. In another example, the fire suppression system 100 can monitor an access barrier 135 of the data processing system 115 (e.g., determine when the access barrier 135 is opened).

The sprinkler 112 can be mounted on or connected with piping 120 and can be any kind of sprinkler, including any type of sprinkler or any orientation of a sprinkler. For example, the sprinkler 112 can be an electronically activated sprinkler (EAS), an early suppression fast response (ESFR) sprinkler, an extended coverage (EC) sprinkler, a control mode density area (CMDA) sprinkler, or a control mode specific application (CMSA) sprinkler, among others. The sprinkler 112 can be, for example, an upright sprinkler, a pendant sprinkler, or a horizontal sprinkler. The sprinkler 112 can be, for example, a ceiling sprinkler or an in-rack sprinkler. The sprinklers 112 can have any of a variety of K-factors, including but not limited to K-factors greater than or equal to 14.0 GPM/PSI² and less than or equal to 36.0 GPM/PSI².

The sprinklers 112 can be either electronically activated sprinklers (EAS) or non-electronically activated sprinklers (non-EAS). A non-EAS can, for example, include at least one activation element (e.g., thermal element). The activation element can change from a first state that prevents fluid flow out of the sprinkler 112 to a second state that permits fluid flow out of the sprinkler 112 responsive to a fire condition. For example, the activation element can include a glass bulb including a fluid that expands responsive to an increase in temperature (e.g., responsive to heat provided to the fluid from a fire), such as to cause the glass bulb to break responsive to the temperature meeting or exceeding a threshold temperature; the activation element can include a fusible link that includes two or more pieces coupled using a solder that can melt responsive to the temperature meeting or exceeding a threshold temperature. The activation element can have a response time index (RTI) less than or equal to 80 (m/s)^{1/2}, or less than or equal to 50 (m/s)^{1/2}. An EAS can, for example, be directly or indirectly coupled with a controller to control fluid discharge and distribution. For example, the EAS can include a sealing assembly supported in place by a removable structure. The controller can provide an electrical pulse or signal to an actuator coupled with the EAS to displace (e.g., break, fracture, eject) the removable structure and the sealing assembly to permit fire suppression fluid 140 discharge.

The sprinkler system 105 can be a wet pipe system or a dry pipe system. For example, the piping 120 in a wet pipe system can be filled with pressurized fire suppression fluid 140 such that the fire suppression fluid 140 is stored very close to the sprinkler 112. Upon activation, the fire suppression fluid 140 can exit the piping 120 through the sprinkler 112 very quickly (e.g., with relatively low or no time delay from activation of the sprinkler 112 to output of the fire suppression fluid 140 from the sprinkler 112).

The piping 120 in a dry pipe system can be filled with pressurized air such that the fire suppression fluid 140 is stored at a location away from the sprinkler 112. The valve 130 can be a barrier between the fire suppression fluid 140 and the piping 120 coupled with the sprinkler 112. The fire suppression fluid 140 cannot move toward the sprinkler 112 until the valve 130 opens. In one example, the valve 130 can open based on an air pressure in the dry pipe system. For example, once the pressure of the pressurized air decreases to a certain pressure, the valve 130 can open and the fire suppression fluid 140 can flow toward and out of the sprinkler 112. In another example, the valve 130 can open based on receiving a signal. In a dry pipe system, receiving a signal to open the valve 130 can allow the valve 130 to open before the air pressure in the piping 120 decreases enough for the valve 130 to open on its own. Waiting for the air pressure to decrease can delay the first suppression fluid 140 from reaching the sprinklers 112 and being provided to the desired area. As such, activating or opening a valve responsive to a signal and provide fire protection faster than activating or opening the valve responsive to detecting a threshold pressure.

The sprinkler system 105 can be used in a variety of applications. The sprinkler system 105 can be used alone or in conjunction with other types of fire suppression systems (e.g., other building sprinkler systems, a handheld fire extinguisher). The sprinkler system 105 can be used with a variety of fire suppression fluids 140, including but not limited to water (e.g., powders, liquids, foams, or other flowable materials).

The sensor 110 of the fire suppression system 100 can be any type of sensor configured to detect various events, system information, etc. For example, the sensor 110 can be a motion sensor that detects movement. In another example, the sensor 110 can be a pressure sensor that detects a pressure or a rate of change in pressure. Other examples of sensors 110 can include a temperature sensor, radiation sensor, sound sensor, force sensor, vibration sensor, infrared sensor, etc.

In one example, the sensor 110 can be disposed at a location such that the sensor 110 can sense system information (e.g., sensor data) corresponding to the sprinkler system 105. The system information can be indicative of a state of the fire suppression system 100 or one or more components thereof. System information corresponding to the sprinkler system 105 can include pressure data of the piping 120 (either air pressure, water pressure, or other fluid pressure), activation status of a sprinkler 112, position of a valve 130 (e.g., open or closed), etc. For example, the sensor 110 can be disposed inside the piping 120 of the sprinkler system 105. Being inside the piping 120, the sensor 110 can sense system information relating to pressure data of the piping 120. In a dry pipe system, the pressure data can include at least one of an air pressure within the piping 120 and a rate of change in air pressure within the piping 120. In a wet pipe system, the pressure data can include at least one of a water pressure within the piping 120 and a rate of change in water pressure within the piping 120. The sensor 110 can detect and output an indication of a state of the sensor 110 (e.g., a state of the sensor 110 itself or another sensor 110, such as an indication of whether the sensor 110 is operating properly).

In another example, the sensor 110 can be disposed at a location such that the sensor 110 can sense system information corresponding to the data processing system 115. In one example, the fire suppression system 100 can include an access barrier 135 of the data processing system 115. The access barrier 135 can be any mechanism configured to protect the data processing system 115. For example, the access barrier 135 can protect the data processing system 115 from being accessed by unauthorized personnel, from being exposed to harmful environmental elements (e.g., water, chemicals, etc.), from getting damaged by external objects, etc. For example, the access barrier 135 can be a protective casing surrounding the data processing system 115. The sensor 110 can be disposed at a location such that the sensor 110 can sense system information corresponding to the access barrier 135. System information corresponding to the access barrier 135 can include entry data of the access barrier 135. The entry data can include at least one of a status of the access barrier 135 (e.g., open or closed, locked or unlocked, etc.), a time when the access barrier 135 was opened (e.g., when the access barrier 135 was opened most recently), and a duration for which the access barrier 135 was open (e.g., the access barrier 135 was open for thirty minutes).

The access barrier 135 can be a housing to surround electronic components of the data processing system 115, such as circuit boards and other processing circuitry. The access barrier 135 can form a seal to prevent ingress of dirt, moisture, or other material into an interior of the access barrier 135, such as to meet sealing standards for data processing components for fire suppression uses.

As an example, the access barrier 135 can be a rigid shell disposed around the data processing system 115 to limit access to, and exposure of, the data processing system 115. The shell can move between a closed position and an open position to provide selective access to the data processing system 115. The sensor 110 can be positioned to sense when the casing moves between the closed and open positions. For example, the sensor 110 can be a force sensor and can be in contact with the casing when the casing is in the closed position. When the casing is in the open position, the force sensed by the sensor 110 is removed. In another example, the sensor 110 can be a motion sensor oriented to sense when the casing is moved. In another example, the sensor 110 can be a camera that incorporates motion sensor technology such that the camera can determine when the casing is being moved or is in an open or closed position. These examples can be applied to any type of access barrier 135.

The data processing system 115 can include an indicator 150. The indicator 150 can be a light emitting element, such as an LED light. The data processing system 115 can control operation of the indicator 150 to present an indication of the state of the fire suppression system 100 or various components thereof. The indicator 150 can have a plurality of output modes, such as to output light of a plurality of colors (i.e., wavelengths), brightnesses or intensities, intermittencies; or various combinations thereof. For example, the data processing system 115 can assign a particular output mode of the plurality of output modes to a respective state of the fire suppression system 100 (e.g., using a lookup table or other data structure that maps states to output modes). The data processing system 115 can identify the state of the fire suppression system 100, select the particular output mode corresponding to the state, and cause the indicator 150 to operate in the particular output mode responsive to selecting the particular output mode.

The indicator 150 can be positioned inside the access barrier 135, such as by being mounted to a circuit board or chip on which processing circuitry of the data processing system 115 is mounted. The access barrier 135 can include a window 152, such as a transparent material, which can be sealed with the access barrier 135. As such, the data processing system 115 can allow light from the indicator 150 to be perceived through the access barrier 135 while maintaining the seal of the access barrier 135 to dirt, moisture, or other materials.

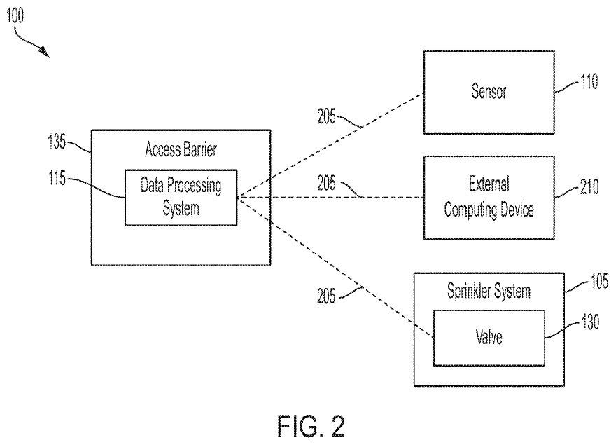

FIG. 2 depicts a schematic diagram of an example fire suppression system 100. In the fire suppression system 100, the data processing system 115 can be communicably coupled with the sensor 110 via at least one connection 205. The connection 205 can be any one or more of a wired and wireless communication. For example, the data processing system 115 can receive a signal from the sensor 110 via connection 205. The signal can indicate the system information (e.g., sensor data) sensed by the sensor 110. For example, the sensor 110 can sense an air pressure within a pipe 120 of a dry pipe system. In one example, the sensor 110 senses an air pressure of 12 pounds per square inch (psi). The data processing system 115 can receive a signal from the sensor 110 indicating the sensed air pressure. For example, the signal can indicate the air pressure within the pipe 120 is 12 psi. In another example, the data processing system 115 can transmit a signal to the sensor 110. For example, the sensor 110 can be programmed to take readings at predetermined times. If the data processing system 115 determines the sensor 110 should take a reading that is not at a predetermined time, the data processing system 115 can send a signal to the sensor 110 to take a reading at that moment in time or at a different time in the future. The data processing system 115 can update the programming of the sensor 110 to modify the predetermined times at which the sensor 110 takes readings.

In another example, the fire suppression system 100 includes a plurality of sensors 110. For example, the fire suppression system 100 can include a first sensor 110 and a second sensor 110. The first sensor 110 can sense system information corresponding to the piping 120 of the sprinkler system 105 and the second sensor 110 can sense system information corresponding to the access barrier 135 of the data processing system 115. For example, the first sensor 110 can sense pressure data of a pipe 120 of a dry pipe sprinkler system 105 and the second sensor 110 can sense entry data of an access barrier 135 of the data processing system 115. The fire suppression system 100 can include any number and any combination of sensors 110. The data processing system 115 can maintain a table or other data structure assigning identifiers to each sensor 110 and/or particular components monitored by each sensor 110, enabling the data processing system 115 to output alerts regarding the state of the fire suppression system 100 that indicate the particular sensor 110 (or particular component monitored by the sensor 110) from which sensor data is received to detect the state.

The data processing system 115 can determine a state of the fire suppression system 100 based on the system information (e.g., sensor data) received via the signal from the sensor 110. The state of the fire suppression system can include, for example, a normal state (e.g., steady state) and a non-normal state. The non-normal state can include, for example, a high/low state (e.g., a supervisory state), an alarm state, and a tampered state. In other examples, a non-normal state can include other states. A non-normal state of a fire suppression system 100 can include any combination of states. For example, the fire suppression system 100 can be in both an alarm state and a tampered state simultaneously. A determination that the fire suppression system 100 is operating in a normal state can indicate that the system information sensed by the sensor 110 and received by the data processing system 115 satisfies a predetermined parameter or threshold associated with the fire suppression system 100. For example, a predetermined parameter can define a normal air pressure (or range of pressure) within a pipe 120 of a dry pipe sprinkler system 105. For example, a normal range of pressure can be between 10 psi and 12 psi. With such a parameter, when the sensor 110 senses a pressure within the pipe 120 to be within the range (e.g., 11 psi) and the data processing system 115 receives a signal from the sensor 110 indicating the pressure is within the range, the data processing system 115 can determine the fire suppression system 100 is operating in a normal state. A determination that the fire suppression system 100 is operating in a non-normal state can indicate that the system information sensed by the sensor 110 and received by the data processing system 115 does not satisfy the predetermined parameter or threshold associated with the fire suppression system 100. For example, a predetermined parameter can require an access barrier 135 of the data processing system 115 to be in a closed position in order for the fire suppression system 100 to be in a normal state. With such a parameter, when the sensor 110 senses the access barrier 135 is moved from a closed position (e.g., when the sensor 110 senses pressure) to an open position (e.g., when the sensor 110 senses no pressure) and the data processing system 115 receives a signal from the sensor 110 indicating the access barrier 135 is open, the data processing system 115 can determine the fire suppression system 100 is operating in a non-normal state.

As such, the data processing system 115 can receive sensor data from at least one sensor 110, compare the sensor data with at least one threshold (e.g., at least one of a minimum threshold and a maximum threshold corresponding to a particular state), and detect a particular state of a plurality of states based on the comparison, such as to detect that the fire suppression system 100 (or a particular component of the fire suppression system 100 corresponding to a particular sensor 110 from which the sensor data is received that is compared with the at least one threshold) is in a normal state, a supervisory state, or an alarm state. The data processing system 115 can detect the normal state responsive to a rate of decrease of pressure being less than a threshold rate. The data processing system 115 can detect the supervisory state responsive to the pressure being less than a minimum threshold or greater than a maximum threshold. The data processing system 115 can detect an alarm state responsive to the rate of pressure decrease being greater than the threshold rate (e.g., air pressure dropping faster than a threshold rate, such as 0.1 psi per second). The data processing system 115 can cause the indicator 150 to operate in a particular output mode of a plurality of output modes corresponding to the detected state, such as to have a green color (e.g., flashing green) responsive to the state being the normal state, a yellow color (e.g., flashing yellow) responsive to the state being the supervisory state, and a red color (e.g., continuous red) responsive to the state being the alarm state. The data processing system 115 (or a control circuit of the fire suppression system 100) can control operation of the valve 130 based on the detected state, such as to open the valve 130 responsive to detecting the alarm state.

The specific non-normal state can depend on which predetermined parameter or threshold is not satisfied. The high/low state (e.g., supervisory state) can be based on an air pressure within a pipe 120 of the sprinkler system 105. For example, the fire suppression system 100 can be in a high/low state if the air pressure within the pipe 120 of the sprinkler system 105 is outside a predefined range. The alarm state can be based on a rate of change of air pressure within the pipe 120 of the sprinkler system 105. For example, the fire suppression system 100 can be in an alarm state if the rate of change of the air pressure within the pipe 120 of the sprinkler system 105 is above a predetermine threshold. The tampered state can be based on entry data associated with an access barrier 135 of the data processing system 115. For example, the fire suppression system 100 can be in a tampered state if the entry data of the access barrier 135 violates a predefined parameter (e.g., entry data indicates the access barrier 135 is open).

Based on the state of the fire suppression system 100, the data processing system 115 can identify a location to apply a voltage. Receiving the voltage at the identified location can indicate the state of the fire suppression system 100. For example, a first location can correspond to the high/low state, a second location can correspond to the alarm state, and a third location can correspond to the tampered state. The data processing system 115 can apply the voltage to the first location when the fire suppression system 100 is in the high/low state. The data processing system 115 can apply the voltage to the second location when the fire suppression system 100 is in the alarm state. The data processing system 115 can apply the voltage to the third location when the fire suppression system 100 is in the tampered state. The magnitude of the voltage can also indicate a state of the fire suppression system. For example, when the fire suppression system 100 is in a high state of the high/low state (e.g., the pressure in the pipe 120 is above a predetermined range), the data processing system 115 can apply a higher voltage (e.g., above 3V) than when the fire suppression system 100 is in a low state of the high/low state (e.g., less than or equal to 3V). In another example, the data processing system 115 can apply a voltage to more than one location indicating more than one predetermined parameter or threshold is not satisfied. For example, the fire suppression system 100 can be in an alarm state and a tampered state simultaneously. In such an example, the data processing system 115 can apply a voltage to the second location and the third location indicating the fire suppression system 100 is in both the alarm state and the tampered state.

The data processing system 115 can be communicably coupled with an external computing device 210 via at least one connection 205. The connection 205 can be any one or more of a wired and wireless communication. For example, the data processing system 115 can transmit a signal to the external computing device 210 that is disposed at a remote location such that the connection 205 is a wireless communication. The signal can indicate the state of the fire suppression system 100. The external computing device 210 can be any device capable of receiving such a signal. For example, the external computing device 210 can be a user device comprising a computing system (e.g., a smart phone, a computer, a laptop, etc.). For another example, the external computing device 210 can be an electronically controlled device (e.g., an electronically controlled valve 130). In some examples, the data processing system 115 can receive a signal from the external computing device 210. The signal received can include a command. For example, the signal can indicate to the data processing system 115 to send a signal to the sensor to take a reading at a particular time.

The data processing system 115 can be communicably coupled with a valve 130. The connection 205 can be any one or more of a wired and wireless communication. In one example, the data processing system 115 can be physically coupled with the valve 130. When the data processing system 115 determines the fire suppression system 100 is in an alarm state, the data processing system can transmit a signal to the valve 130 to open the valve. In another example, the data processing system 115 can be disposed at a remote location.

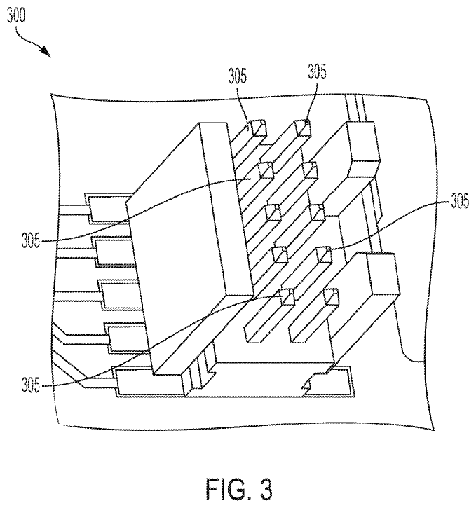

FIG. 3 depicts a system connector 300. In one example, the system connector 300 can couple with the data processing system 115. For example, the data processing system 115 can include a circuit board, and the system connector 300 can connect to the circuit board. The system connector 300 can facilitate the determination of the state of the fire suppression system 100. For example, the system connector 300 can include at least one pin 305 that corresponds to the location that receives the voltage. In some examples, the system connector 300 can include a plurality of pins 305. For example, a first pin 305 can be associated with a high/low state of the fire suppression system 100 such that applying a voltage to the first pin 305 can indicate the fire suppression system 100 is in a high/low state. A second pin 305 can be associated with an alarm state such that applying a voltage to the second pin 305 can indicate the fire suppression system 100 is in an alarm state. A third pin 305 can be associated with a tampered state of the fire suppression system 100 such that applying a voltage to the third pin 305 can indicate the fire suppression system 100 is in a tampered state. In some examples, the system connector 300 includes at least one pin 305 that does not correspond to a state of the fire suppression system 100. For example, the system connector 300 can include a pin that corresponds to at least one of a transmitter, a receiver, a power source, and an analog/digital system, among others.

In some examples, the system connector 300 can facilitate the transmission of the signal indicating the state of the fire suppression system 100 to at least one of the indicator 150, the external computing device 210, and the valve 130. For example, the system connector 300 can provide an easy connection point for a transmission module. The transmission module can be any module capable of transmitting a signal from the data processing system 115 to the external computing device 210. For example, the transmission module can be a radio frequency module that can send radio waves to the external computing device 210 indicating the state of the fire suppression system 100.

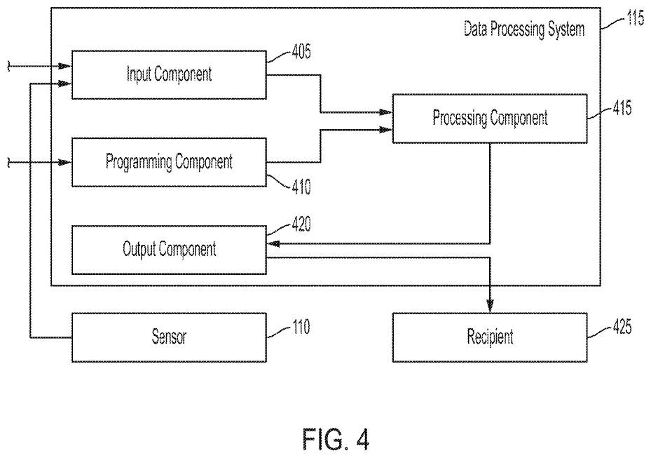

FIG. 4 depicts a schematic diagram of an example data processing system 115. As depicted in FIG. 4, the data processing system 115 can be structured for receiving, processing, and generating various inputs and outputs. In one example, the data processing system 115 can include at least one input component 405, at least one programming component 410, at least one processing component 415, and at least one output component 20. The input component 405 can receive signals from the sensor 110 indicating the system information sensed by the sensor 110. The input component 405 can receive a command. The command can cause the data processing system 115 to perform an identified task. For example, the input component 405 can receive a command to determine the state of the fire suppression system 100. For example, when the data processing system 115 is not programmed to make such determinations continuously, the command can cause the data processing system 115 to make a determination at a new specified time. For example, the data processing system 115 can be programmed to determine the state of a fire suppression system 100 at the same time every day (e.g., eight o'clock every morning). The data processing system 115 can receive a command to determine the state of the fire suppression system 100 at a different time during the day. The command can be for a single determination. The determination can be at the time the command is received. The determination can be at a time specified by the command. The command can override or change the predetermined schedule. For example, the command can affect the time, the frequency, etc. of the predetermined schedule. For example, the command can change the determination time from a first time of day (e.g., 8 o'clock every morning) to a second time every day (e.g., eleven o'clock every evening). In another example, the command can change the frequency of the determination. For example, the command can change the frequency from daily to weekly.

Responsive to the receipt of the command, the data processing system 115 can transmit a signal to a sensor 110 to cause the sensor 110 to sense the system information requested by the command. For example, the command can indicate for what component of the fire suppression system 100 the data processing system 115 should determine a state. For example, the command can include a request for the overall state of the fire suppression system 100 such that all sensors 110 included in the fire suppression system 100 can sense system information and transmit a signal to the data processing system 115 indicating the sensed system information. In another example, the command can include a request for a determination corresponding to a specific subset of the components of the fire suppression system. For example, the command can include a request for a determination corresponding to the air pressure within the piping 120 of the sprinkler system 105. The data processing system 115 can transmit a signal to at least one sensor 110 that can sense pressure within the piping 120 of the sprinkler system 105.

The programming component 410 can receive input indicating at least one user defined parameter, criteria, or rule that can define when a fire suppression system 100 is in a normal state and a non-normal state, when a signal should be transmitted to a valve 130 of a sprinkler system 105, or when a signal should be transmitted to an external computing device, etc. For example, the programming component 410 can receive instructions indicating a predetermined range that defines the pressure boundaries for a fire suppression system 100 in a normal state. For example, the instructions can indicate that the fire suppression system 100 is in a normal state when an air pressure within a pipe 120 of a dry pipe sprinkler system 105 is between 10 psi and 12 psi. In another example, the instructions can indicate that the fire suppression system 100 is in a normal state when a rate of change in air pressure is below a predetermined rate of change (e.g., less than 0.1 psi/second) and when an access barrier 135 of the data processing system 115 is in a predetermined position (e.g., a closed position). For example, if the air pressure in a pipe 120 is 9 psi, the fire suppression system 100 can be in a high/low state, and specifically a low state. If, for example, a rate of change of air pressure in the pipe 120 is 0.5 psi/second, the fire suppression system 100 can be in an alarm state. If, for example, the access barrier 135 of the data processing system 115 is in an open position, the fire suppression system 100 can be in a tampered state.

The instructions provided to the data processing system 115 via the programming component 410 can indicate which location corresponds to which state. For example, the instructions can indicate that a first location (e.g., a first pin 305) corresponds to a first state, a second location (e.g., a second pin 305) corresponds to a second state, and a third location (e.g., a third pin 305) corresponds to a third state. Therefore, the data processing system 115 can determine where to apply a voltage depending on the signal received from the sensor 110.

The instructions provided to the data processing system 115 via the programming component 410 can provide a predetermined threshold defining when the data processing system 115 can send a signal to a valve 130 of the sprinkler system 105 to open the valve 130 such that fire suppression fluid can flow through the piping 120 and exit through an outlet (e.g., sprinkler 112). For example, the predetermined threshold can be a rate of decrease in air pressure of 0.1 psi/second. When the rate of decrease of air pressure exceeds that predetermined threshold, the data processing system 115 can send a signal to the valve 130 to open the valve 130.

The instructions provided to the data processing system 115 via the programming component 410 can provide a predetermined schedule for the data processing system 115 to transmit a signal to an external computing device 210. For example, the predetermined schedule can indicate at least one of transmitting a signal continuously (e.g., real time updates), transmitting a signal periodically (e.g., once every five minutes), and transmitting a signal upon command (e.g., only when the date processing system 115 receives instructions from a user device (e.g., external computing device 210) to provide an update on the state of the fire suppression system 100). The instructions provided to the data processing system 115 via the programming component 410 can be stored, updated, and removed at any time. In other examples, the instructions can only be updated or removed at certain times or by certain people.

The processing component 415 can process the input from the input component 405 and the instructions from the programming component 410. For example, the processing component 415 can compare the input (e.g., the system information) received from the sensor 110 with a predetermined parameter from the programming component 410 to determine the state of the fire suppression system 100. For example, the input component 405 can receive a signal indicating an air pressure within a pipe 120 (e.g., 11 psi). The processing component 415 can compare the air pressure with the predetermined pressure range (e.g., 10 psi-12 psi) from the programming component 410. Based on the comparison, the processing component 415 can determine the fire suppression system 100 is in the normal state (at least with respect to pressure within the pipe 120).

The output component 420 can determine an output based on the state of the fire suppression system 100. For example, the output component 420 can generate a signal to transmit to a recipient 425. The recipient 425 can be at least one of an external computing device 210, an indicator 150, and a valve 130. The signal can indicate the general state of the fire suppression system (e.g., normal, non-normal). The signal can indicate the specific state of the fire suppression system (e.g., high/low, alarm, tampered). The signal can include at least some of the system information considered when determining the state of the fire suppression system 100. For example, when the fire suppression system 100 is operating in a normal state, the signal transmitted to the external computing device 210 can include at least one of an air pressure in the pipe 120 of the sprinkler system 105, a rate of change of the air pressure in the pipe of the sprinkler system 105, and an indication that the access barrier 135 of the data processing system 115 is in a certain position. In some examples, the signal can indicate the predetermined parameters previously provided to the input component 405 of the data processing system 115 so the external computing device can compare the sensed system information with the predetermined parameters. When the fire suppression system 100 is operating in a non-normal state, the output component 420 can generate a signal containing at least some of the system information considered when determining the state of the fire suppression system 100. In another example, the output component 20 can generate a signal that only contains the system information for the components that are causing the fire suppression system 100 to operate in a non-normal state. For example, if the air pressure in the pipe 120 is the only system information that does not satisfy the predetermined parameters, the signal can include only the system information corresponding to the air pressure of the pipe 120. In one example, if the external computing device 210 is or includes a display device (e.g., computer, smartphone, etc.), the signal can include a user interface to be displayed on the display device. The user interface can display the information included in the signal. The output component 420 can include or be coupled with the indicator 150 described with reference to FIG. 1, such as to control operation of the indicator 150 to cause the indicator 150 to output a particular indication corresponding to the state of the fire suppression system 100 detected by the data processing system 115.

In another example, the output component 420 can generate a signal to cause an electronically controlled component of the fire suppression system 100 to perform a function. For example, the output component 420 can generate a signal to cause the valve 130 of the fire suppression system 100 to open such that fire suppression fluid can reach an outlet. For example, instead of the valve 130 having to wait until the pressure within the pipe decreases to a certain threshold to open, the output component 420 of the data processing system 115 can transmit a signal to the valve 130 to cause to valve 130 to open before the pressure reaches the threshold. In some examples, the output component 420 can generate a plurality of signals to transmit to a plurality of recipients 425.

The external computing device 210 can send a command to the data processing system. For example, the data processing system 115 can receive a command to determine the pressure inside a pipe 120 of the sprinkler system 105 at a specific time. The data processing system 115 can receive a command to determine the state of the fire suppression system 100.

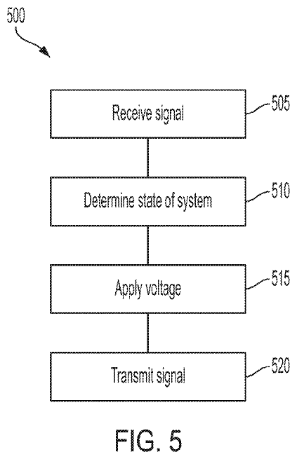

FIG. 5 depicts a flow diagram of a method 500. The method 500 can be a method of monitoring a fire suppression system 100. The method 500 can include receiving at least one signal 505, determining at least one state of the fire suppression system 510, applying at least one voltage 515, and transmitting at least one signal 520. Act 505 of receiving at least one signal can include a data processing system 115 receiving a signal from a sensor 110. The signal can indicate system information (e.g., sensor data) corresponding to at least one component of the fire suppression system 100. For example, the signal can include system information corresponding to a pressure within piping 120 of a sprinkler system 105. In another example, the signal can include system information corresponding to a plurality of components of the fire suppression system 100 that has information to be sensed by a sensor 110. For example, the signal can include the pressure information corresponding to the piping 120 of the sprinkler system 105 and status information corresponding to an access barrier 135 of the data processing system 115. The system information can be received by the data processing system 115 via a single signal. For example, one sensor 110 can sense the system information and send a single signal for the data processing system 115 to receive.

In another example, the system information can be received by the data processing system 115 via a plurality of signals. For example, a first sensor 110 can sense a first subset of the system information and a second sensor 110 can sense a second subset of the system information. The data processing system 115 can receive a first signal from the first sensor 110 indicating the first subset of the system information and receive a second signal from the second sensor 110 indicating the second subset of the system information. For example, the first signal can indicate system information relating to pressure data of a dry pipe of the fire suppression system 100 and the second signal can indicate system information relating to entry data of an access barrier 135 of the data processing system 115.

Determining a state of the fire suppression system 100 at act 510 can be based, at least in part, on the system information received from the sensor 110 via the signal. Determining a state of the fire suppression system 100 can include the data processing system 115 receiving instructions and the data processing system 115 comparing the system information received from the sensor 110 via the signal with the instructions. For example, the data processing system 115 can receive instructions indicating what system information indicates a normal state and what system information indicates a non-normal state. For example, the instructions can provide a predetermined range to determine whether the fire suppression system 100 can be in a high/low state. The instructions can provide a predetermined threshold to determine whether the fire suppression system 100 is in an alarm state. The instructions can provide a predetermined parameter to determine whether the fire suppression system 100 is in a tampered state.

The data processing system 115 can compare the system information received from the sensor 110 with the instructions. For example, the instructions can indicate that if a pressure within a pipe 120 of a sprinkler system 105 is between a predetermined range (e.g., 10 psi-12 psi), the fire suppression system 100 can be in a normal state. If the pressure is below the predetermined range, the fire suppression system 100 can be in a high/low state. The data processing system 115 can compare a pressure indicated by the signal received from the sensor 110 with the predetermined range. For example, if the signal indicates a pressure within the predetermined range (e.g., 11 psi), the data processing system 115 can determine the fire suppression system 100 is operating in a normal state. The instructions can indicate that if a rate of change of pressure within a pipe 120 of the sprinkler system 105 is equal to or below a predetermined pressure threshold (e.g., 0.1 psi/second), the fire suppression system 100 can be in a normal state. If the rate of change is above the predetermined pressure threshold (e.g., above 0.1 psi/second), the fire suppression system 100 can be in an alarm state. The data processing system 115 can compare a rate of change of pressure indicated by the signal received from the sensor with the predetermined pressure threshold. For example, if the signal indicates a rate of change in pressure above the predetermined pressure threshold (e.g., 1 psi/second), the data processing system 115 can determine the fire suppression system 100 is in an alarm state. The instructions can indicate that if an access barrier 135 of the data processing system 115 is in a predetermined position (e.g., a closed position), the fire suppression system 100 can be in a normal state. If the access barrier 135 is not in the predetermined position (e.g., an open position), the fire suppression system 100 can be in a tampered state. The data processing system 115 can compare the position of the access barrier 135 indicated by the signal received from the sensor 110 with the predetermined position. For example, the sensor 110 can sense system information corresponding to the position of the access barrier 135. The data processing system 115 can receive the system information indicating the position of the access barrier 135. The data processing system 115 can compare the position of the access barrier 135 with the predetermined position received via the instructions. If the access barrier 135 is not in the predetermined position, the data processing system 115 can determine the fire suppression system 100 is operating in a tampered state.

Applying a voltage at act 515 can include identifying a location at which to apply the voltage. The location can be based, at least in part, on the state of the fire suppression system 100. For example, applying the voltage to a first location can indicate a high/low state, applying the voltage to a second location can indicate an alarm state, and applying a voltage to a third location can indicate a tampered state. The fire suppression system 100 can include any number of locations to which a voltage can be applied. The data processing system 115 can apply a voltage to a single location. For example, with the fire suppression system 100 is in an alarm state, the data processing system 115 can apply a voltage at the second location. The data processing system 115 can apply a voltage at a plurality of locations. For example, with the fire suppression system 100 in an alarm state and a tampered state, the data processing system 115 can apply a voltage to the second location and a voltage to the third location.

Applying the voltage can also include determining a magnitude of the voltage to apply. The magnitude can be based, at least in part, on the state of the fire suppression system 100. For example, a fire suppression system 100 can be in a high/low state if a pressure inside a pipe of the sprinkler system 105 is above a predetermined threshold (e.g., a high state) or when the pressure is below a predetermined threshold (e.g., a low state). The data processing system 115 can apply a voltage to the same location for both a high state and a low state, but the magnitude of the voltage can be specific for each of the high state and the low state. For example, the data processing system 115 can apply a voltage to a location that is less than or equal to a predetermined voltage (e.g., 3V) to indicate a low state. The data processing system 115 can apply a voltage to the same location that is above the predetermined voltage to indicate a high state. Other states that have different levels or sub-states can use different magnitudes of voltage to differentiate between them. For example, the fire suppression system 100 can be in an alarm state because a rate of change in pressure in a pipe can be above a predetermined threshold. The voltage applied by the data processing system 115 can be based, at least in part, on how much over the threshold the rate of change in pressure is. For example, if the rate is higher than the threshold rate by less than a predetermined amount (e.g., 10%), the voltage can be less than or equal to a predetermined voltage (e.g., 3V). If the rate is higher than the threshold rate by more than the predetermined amount, the voltage can be over the predetermined voltage. There can be other ranges indicating other sub-states. Once the location is identified and the voltage is determined, the data processing system 115 can apply the determined voltage to the identified location.

When the data processing system 115 applies voltages to a plurality of locations, the voltages can be different. For example, the data processing system 115 can apply a first voltage to a first location. The first voltage can be, for example, 5V. The data processing system 115 can also apply a second voltage to a second location. The second voltage can be, for example, 2V. In other examples, the voltages applied to a plurality of locations can be the same.

Transmitting a signal at act 520 can include the data processing system 115 transmitting a signal to a recipient 425. The recipient 425 can be at least one of an external computing device 210, an indicator 150, and a valve 130. The signal can indicate the state of the fire suppression system 100. Transmitting a signal can also include the data processing system 115 determining at least one of if it can send the signal, what information to include in the signal, where to send the signal, and when to send the signal. Determining each of these can be based, at least in part, on at least one of the instructions received by the data processing system 115 and a command received by the data processing system 115, and any combination thereof. For example, regarding whether the data processing system 115 can send the signal, the instructions can indicate that the data processing system 115 can send a signal every time the data processing system 115 receives a signal from the sensor 110. In another example, the instructions can indicate that the data processing system 115 can only send a signal when the data processing system 115 determines the fire suppression system 100 is in a non-normal state. Regarding what information to include in the signal, the instructions can indicate that the signal only include whether the fire suppression system is in a normal state or a non-normal state. In another example, the instructions can indicate to include the specific non-normal state of the fire suppression system 100 (e.g., the fire suppression system 100 is in a high/low state). In another example, the instructions can indicate to include the system information sensed by the sensor 110 (e.g., the air pressure within the pipe is 10 psi). The instructions can instruct the data processing system 115 to include any combination of information in the signal.

Regarding where to send the signal, the instructions can indicate to send the signal to a specified external computing device 210 (e.g., a specific computer system, a specific email address, etc.). In one example, the instructions can indicate different external computing devices based on the determined state of the fire suppression system 100. For example, the instructions can include sending a signal to a first external computing device if the state of the fire suppression system 100 is normal. If the state is non-normal, the instructions can indicate sending the signal to a different external computing device. In another example, with a normal state, the instructions can include sending a signal to one external computing device. With a non-normal state, the instructions can include sending a signal to a plurality of external computing devices.

Regarding when the data processing system 115 can send the signal, the instructions can indicate that the data processing system 115 can send the signal as soon as it determines all other necessary information (e.g., where to send the signal, what to include in the signal, etc.). In another example, the instructions can indicate a specific time of day to send a signal (e.g., only send signals at nine o'clock in the morning). In other examples, the instructions can have different directions for different states. For example, the instructions can include sending a signal at nine o'clock in the morning if the state is determined to be normal, but send the signal immediately (e.g., whenever the data processing system 115 determines the state) when the state is determined to be non-normal.

Method 500 can also include the data processing system 115 receiving a command to determine the state of the fire suppression system 100. The command can indicate, for example, whether to send a signal, what to include in the signal, where to send the signal, and when to send the signal, among other limitations. For example, the command can cause the data processing system 115 to make a determination at a time not previously established by the instructions. For example, the data processing system 115 can be programmed to determine the state of the fire suppression system 100 at a first frequency (e.g., daily). If the data processing system 115 already determined the state of the fire suppression system 100 for a day, the command received by the data processing system 115 can cause the data processing system 115 to determine the state of the fire suppression system 100 again at another time during the day. The command can indicate whether the data processing system 115 is to make the determination upon receipt of the command (e.g., immediately after receiving the command). In another example, the command can indicate a time in the future for the data processing system 115 to make another determination. The command can include a single determination request, or can have multiple for various scheduled times. In some examples, responsive to receiving the command, the data processing system 115 can transmit a signal to a sensor 110. The signal can indicate to the sensor 110 to sense system information indicative of the state of the fire suppression system 100. In another example, the instructions from the command can override previous instructions provided to the data processing system via the programming component 410.

Method 500 can also include the data processing system 115 sending a signal to a component of the fire suppression system 100. For example, the sensor 110 can be disposed in a pipe 120 of the sprinkler system 105. The sensor 110 can sense a rate of change in air pressure within the pipe 120 that is greater than a predetermined threshold. The data processing system 115 can receive a signal from the sensor 110 indicating the rate of change in air pressure is greater than the predetermined threshold. The data processing system 115 can determine the fire suppression system 100 is in an alarm state based on the rate of change in air pressure in the pipe 120 is above the predetermined threshold. Responsive to determining the system is in an alarm mode, the data processing system 115 can transmit a signal to the valve 130 to open the valve 130 so that fire suppression fluid 140 can exit through the sprinkler 112.

Method 500 can include outputting an indication of the state using a device of the data processing system 115, such as indicator 150. For example, the data processing system 115 can select a particular operating mode of the indicator 150 based on the state (e.g., particular color), and cause the indicator 150 to operate in the particular operating mode. The data processing system 115 can periodically evaluate the state and modify the operating mode of the indicator 150 responsive to a change in the state.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A fire suppression system, comprising:
a data processing system communicably coupled with a sensor, the sensor to detect sensor data indicative of a state of the fire suppression system, the data processing system to:
receive a signal from the sensor indicating the sensor data;
determine the state of the fire suppression system based on the sensor data;
identify a location of a system connector to apply a voltage in order to indicate the state of the fire suppression system;
apply the voltage to the location; and
at least one of (i) transmit, responsive to application of the voltage to the location, an indication of the state of the fire suppression system to an external computing device and (ii) cause an indicator to present the indication.

2. The system of claim 1, comprising:
the state of the fire suppression system is at least one of a supervisory state, an alarm state, and a tampered state.

3. The system of claim 1, comprising:
the data processing system is to compare the sensor data with a predetermined threshold to determine the state of the fire suppression system, the state of the fire suppression system being at least one of a supervisory state, an alarm state, and a tampered state.

4. The system of claim 1, comprising:
the sensor data corresponds to at least one of a sprinkler system and the data processing system.

5. The system of claim 1, comprising:
the sensor data corresponds to at least one of pressure data of a dry pipe sprinkler system, pressure data of a wet pipe sprinkler system, and entry data of an access barrier of the data processing system.

6. The system of claim 1, comprising:
the sensor is a first sensor, the data processing system is communicably coupled with a second sensor, the first sensor to sense pressure data of a pipe of a dry pipe sprinkler system and the second sensor to sense entry data of an access barrier of the data processing system.

7. The system of claim 1, comprising:
the sensor data indicated by the signal received from the sensor corresponds to entry data of an access barrier of the data processing system, the entry data including at least one of a status of the access barrier, a time when the access barrier was opened, and a duration for which the access barrier was open.

8. The system of claim 1, comprising:
the sensor data indicated by the signal received from the sensor corresponds to pressure data of at least one of a dry pipe of the fire suppression system and a wet pipe of the fire suppression system, the pressure data including at least one of a pressure and a rate of change of pressure.

9. The system of claim 1, comprising:
the location to apply the voltage is at least one of a first location, a second location, and a third location, the first location corresponding to a supervisory state, the second location corresponding to an alarm state, and the third location corresponding to a tampered state.

10. The system of claim 1, comprising:
the location corresponds to a supervisory state, and
the voltage being less than or equal to a voltage threshold applied to the location indicates a low pressure state and the voltage being above the voltage threshold applied to the location indicates a high pressure state.

11. The system of claim 1, comprising:
the data processing system to:
receive a command to determine the state of the fire suppression system; and
responsive to receiving the command to determine the state of the fire suppression system, transmit a command signal to the sensor to cause the sensor to detect the sensor data.

12. The system of claim 1, comprising:
the external computing device disposed at a remote location, the data processing system to transmit the signal to the external computing device via a wireless connection.

13. The system of claim 1, comprising:
the data processing system to transmit the indication of the state of the fire suppression system to the external computing device based on a predetermined schedule, the predetermined schedule indicating at least one of transmitting the indication continuously, transmitting the indication periodically, and transmitting the indication responsive to a command.

14. The system of claim 1, comprising:
the sensor to detect the sensor data based on previously provided instructions, the previously provided instructions causing the sensor to continuously sense the sensor data,
the data processing system to apply the voltage to the location only when the sensor data received via the signal from the sensor indicates a non-normal state.

15. The system of claim 1, comprising:
the sensor data includes a rate of change of air pressure in a pipe indicative of an alarm state; and
the data processing system to transmit a command signal to a valve coupled with a sprinkler system, the command signal causing the valve to open.

16. A method, comprising:
receiving, by a data processing system, a signal from a sensor, the signal indicating system information, the system information associated with a fire suppression system;
determining, by the data processing system, a state of the fire suppression system based on the system information;
identifying, by the data processing system, a location of a system connector to apply a voltage in order to indicate the state of the fire suppression system;
applying, by the data processing system, the voltage to the location;
emitting, by an indicator of the data processing system, light indicative of the state; and
transmitting, by the data processing system, an indication of the state of the fire suppression system to an external computing device.

17. The method of claim 16, comprising:
the signal from the sensor is a first signal from a first sensor;
further comprising receiving a second signal from a second sensor,
the first signal indicating a first subset of the system information that relates to pressure data of a dry pipe of the fire suppression system and the second signal indicating a second subset of the system information that relates to entry data of an access barrier of the data processing system.

18. The method of claim 16, comprising:
the location to apply the voltage is at least one of a first location, a second location, and a third location,
applying, by the data processing system, the voltage to the first location indicates a high/low state, applying, by the data processing system, the voltage to the second location indicates an alarm state, and applying, by the data processing system, the voltage to the third location indicates a tampered state.

19. The method of claim 16, comprising:
receiving, by the data processing system, a command to determine the state of the fire suppression system; and
responsive to receiving the command to determine the state of the fire suppression system, transmitting, by the data processing system, a command signal to the sensor to cause the sensor to sense information indicative of the state of the fire suppression system.

20. The method of claim 16, comprising:
the system information includes a rate of change in air pressure in a dry pipe system indicative of an alarm state;
transmitting, by the data processing system, a command signal to a valve coupled with the dry pipe system of the fire suppression system, the command signal causing the valve to open to allow fire suppression fluid to flow through the dry pipe system to an outlet.
